(19) United States
(12) Patent Application Publication
(10) Pub. No.: US 2006/0256090 A1
(43) Pub. Date: Nov. 16, 2006

(54) Mechanical overlay

(75) Inventor: Brian Q. Huppi, San Francisco, CA (US)

Correspondence Address: BEYER WEAVER & THOMAS, LLP, P.O. BOX 70250, OAKLAND, CA, 94612-0250, US

(73) Assignee: Apple Computer, Inc.

(21) Appl. No.: 11/128,533

(22) Filed: May 12, 2005

(51) Int. Cl. G09G 5/00

(52) U.S. Cl. 345/173

(57) ABSTRACT

Mechanical overlays for placement over touch sensing devices are disclosed. The mechanical overlays include one or more mechanical actuators that provide touch inputs to the touch sensing devices.

### CROSS REFERENCE TO RELATED APPLICATIONS

This application is related to the following applications, which are all herein incorporated by reference:

U.S. patent application Ser. No. 10/188,182 entitled “TOUCH PAD FOR HANDHELD DEVICE,” filed on Jul. 1, 2002;

U.S. patent application Ser. No. 10/722,948 entitled “TOUCH PAD FOR HANDHELD DEVICE,” filed on Nov. 25, 2003;

U.S. patent application Ser. No. 10/840,862 entitled “MULTIPOINT TOUCHSCREEN,” filed on May 6, 2004;

U.S. patent application Ser. No. 10/903,964 entitled “GESTURES FOR TOUCH SENSITIVE INPUT DEVICES,” filed on Jul. 30, 2004;

U.S. patent application Ser. No. 11/038,590 entitled “MODE-BASED GRAPHICAL USER INTERFACES FOR TOUCH SENSITIVE INPUT DEVICES,” filed on Jan. 18, 2005;

U.S. patent application Ser. No. 11/015,978 entitled “TOUCH-SENSITIVE ELECTRONIC APPARATUS FOR MEDIA APPLICATIONS, AND METHODS THEREFOR,” filed on Dec. 17, 2004;

U.S. patent application Ser. No. 10/927,575 entitled “WIDE TOUCHPAD ON A PORTABLE COMPUTER” filed on Aug. 25, 2004; and

U.S. patent application Ser. No. 10/927,577 entitled “METHOD AND APPARATUS TO REJECT ACCIDENTAL CONTACT ON TOUCHPAD” filed on Aug. 25, 2004.

### BACKGROUND OF THE INVENTION

1. Field of the Invention

The present invention relates generally to overlays for touch sensing devices. More particularly, the present invention relates to mechanical overlays that include one or more mechanical actuators that provide touch inputs to the touch sensing devices.

2. Description of the Related Art

There exist today many styles of input devices for performing operations in an electronic system. By way of example, the input devices may include rudimentary mechanical controls such as buttons, keys, dials, sliders, navigation pads, joy sticks, that are mechanically actuated and electrically controlled via tact switches, encoders, and the like, or more advanced touch controls such as touch pads and touch screens that allow a user to make selections and move a cursor by simply touching the touch surface via a finger or stylus.

Unfortunately, these conventional approaches do not fully satisfy user needs. For example, the rudimentary mechanical controls tend to be fixed and inflexible (not easily adjusted or configured for a new task). Further, each one includes electronic hardware that increases the cost of the device. In large control panels, which include a vast number of mechanical controls, the costs can be exorbitantly high. Moreover, while the rudimentary mechanical controls typically provide tactile cues (clicks), the more advanced touch sensing devices do not. As such, the user does not know when the device has produced a touch input. In some cases, a simple decal is provided over the touch pad to indicate the location of dedicated touch controls. This however, requires the user to look carefully at the surface while the touch pad is being used thereby slowing down productivity. Furthermore, it provides no indication of whether something has been selected.

Thus, there is a need for improved approaches for input control devices.

### SUMMARY OF THE INVENTION

The invention relates, in one embodiment, to an input control device. The input control device includes a touch sensing device having a touch input area. The input control device also includes a mechanical overlay provided on or over the touch input area of the touch sensing device. The mechanical overlay has one or more mechanical input mechanisms that provide the touch input to the touch input area via a mechanical action.

The invention relates, in another embodiment, to a mechanical overlay for a touch sensing device. The mechanical overlay includes a base configured for placement on or over a touch sensitive surface of the touch sensing device. The mechanical overlay also includes one or more mechanical actuators that move relative to the base. The motion of the mechanical actuators are configured to cause activation of the touch sensitive surface of the touch sensing device.

The invention relates, in another embodiment, to a mechanical overlay for a touch sensing device. The mechanical overlay includes a base configured for placement on or over a touch sensitive surface of the touch sensing device. The mechanical overlay also includes one or more mechanical actuators that move relative to the base. The motion of the mechanical actuators are configured to cause activation of the touch sensitive surface of the touch sensing device. The one or more mechanical actuators include at least a button that translates relative to the base between an upright and depressed position. The button activates the touch sensitive surface when the button is moved from the upright to the depressed position.

The invention relates, in another embodiment, to a computing device. The computing device includes a touch surface provided by one of a touch pad, touch screen or touch sensitive housing. The computing device also includes a mechanical overlay including one or more mechanical actuators that interface with the touch surface in order to generate touch inputs. The touch inputs are used by the computing device to perform actions in the computing device.

The invention relates, in another embodiment, to an overlay method. The method includes determining the identity of a mechanical overlay. The method also includes generating touch data when one or more mechanical actuators of the mechanical overlay are moved. The method further includes transforming the touch data into control event signals. The method additionally includes performing one or more actions based on the control event signals.

The invention relates, in another embodiment, to a method performed in a control input device having a touch sensing device and a mechanical overlay. The method includes sensing a change in an ID region of the touch sensing device. The change occurs when a new mechanical overlay is positioned over the touch sensing device. The method also includes reading the ID signature of the new mechanical overlay when a change is sensed in the ID region. The method further includes registering the ID signature and configuring a host system based on the ID signature.

The invention relates, in another embodiment, to a control panel. The control panel includes a removable mechanical overlay including a plurality of mechanical actuators selected from at least sliders, buttons, dials or switches. The control panel also includes a touch sensing device configured to recognize multiple touch event generated by the plurality of actuators at the same time, and to report the multiple touch events to a host computing device.

The invention relates, in another embodiment, to a computing device. The computing device includes a touch sensing device having a touch sensitive surface. The computing device also includes a removable mechanical overlay for placement over the touch sensitive surface. The removable mechanical overlaying includes an identification (ID) feature and one or more mechanical actuators for interacting with the touch sensitive surface. The computing device is configured to identify the mechanical overlay via the ID feature of the mechanical overlay, and to configure itself based on the identified mechanical overlay.

### BRIEF DESCRIPTION OF THE DRAWINGS

The invention may best be understood by reference to the following description taken in conjunction with the accompanying drawings in which:

FIG. 1 is a perspective diagram of an input control device, in accordance with one embodiment of the present invention.

FIG. 2 is a top view diagram of an input control device, in accordance with one embodiment of the present invention.

FIG. 3 is a side elevation view in cross section of a button or key which can be used on the mechanical overlay, in accordance with one embodiment of the present invention.

FIG. 4 is a side elevation view in cross section of a dial which can be used on the mechanical overlay, in accordance with one embodiment of the present invention.

FIG. 5 is a side elevation view in cross section of a mechanical slider which can be used on the mechanical, in accordance with one embodiment of the present invention.

FIG. 6 is a side elevation view in cross section of a mechanical switch which can be used on the mechanical overlay, in accordance with one embodiment of the present invention.

FIG. 7 is a side elevation view in cross section of a button or key which can be used on the mechanical overlay, in accordance with one embodiment of the present invention.

FIG. 8 is a flow diagram of an overlay method, in accordance with one embodiment of the present invention.

FIG. 9 is a flow diagram of a method, in accordance with one embodiment of the present invention.

FIG. 10 is a multipoint touch method, in accordance with one embodiment of the present invention.

FIG. 11 is a block diagram of a computer system, in accordance with one embodiment of the invention.

FIG. 12 illustrates an embodiment where the touch sensing input device is a touch pad built into a laptop computer.

FIGS. 13A and 13B illustrate embodiments where the touch sensing input device is a touch sensitive housing member located on the top surface of the base of the laptop computer.

FIG. 14 illustrates an embodiment where the touch sensing input device is positioned in a tablet device such as a stand alone tablet touch input device or a tablet PC that includes a touch screen display.

FIG. 15 illustrates an embodiment where the touch sensing input means is built into a handheld electronic device.

FIGS. 16A-16F are examples different mechanical overlays that may be placed on the multi-functional device, in accordance with one embodiment of the present invention.

### DETAILED DESCRIPTION OF THE INVENTION

The invention pertains to overlays for touch sensing devices. More particularly, the invention pertains to mechanical overlays that include one or more mechanical actuators that provide touch inputs to the touch sensing devices. By way of example, the mechanical actuators may be buttons, keys, sliders, dials, wheels, switches, joysticks, navigation pads, etc. In one embodiment, the mechanical overlay includes a plurality of mechanical actuators so as to provide a control panel or control console to a host device. In fact, the touch sensing devices may be multi-touch sensing devices that have the ability to sense multiple inputs from multiple mechanical actuators at the same time. In another embodiment, the mechanical overlay includes an identification feature that is capable of being sensed by the touch sensing device. When identified, the touch sensing device may configure itself or the host system based on the identified mechanical overlay.

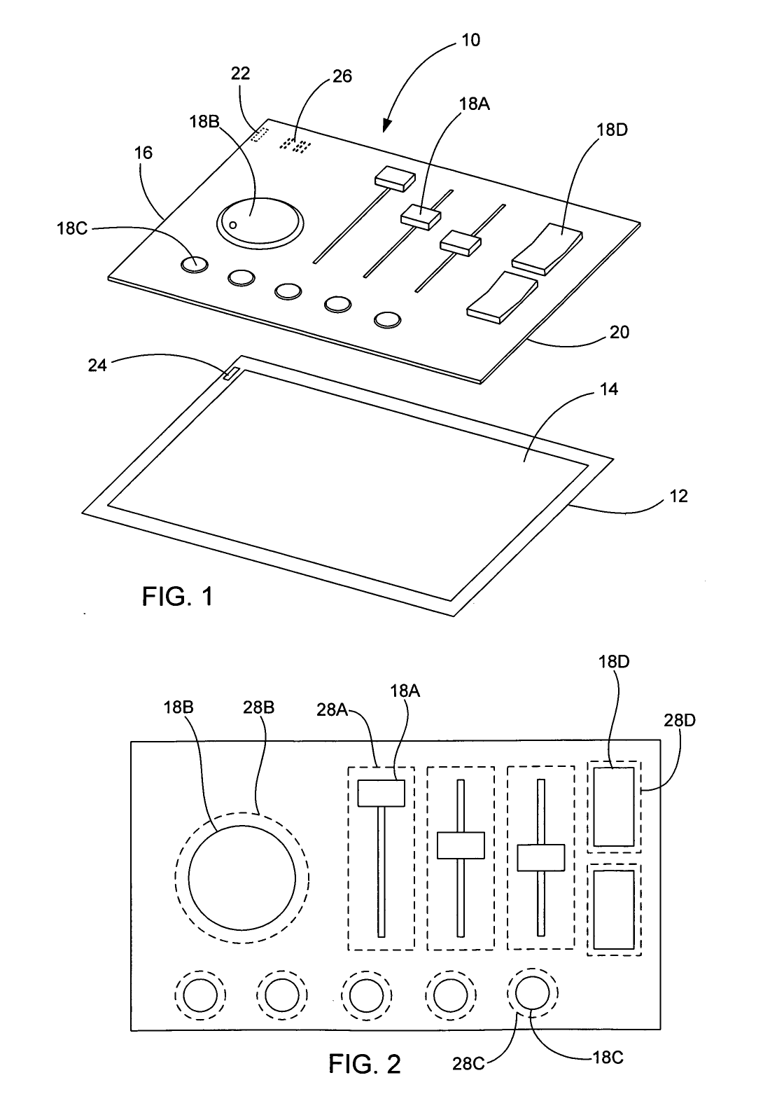

Embodiments of the invention are discussed below with reference to FIGS. 1-16F. However, those skilled in the art will readily appreciate that the detailed description given herein with respect to these figures is for explanatory purposes as the invention extends beyond these limited embodiments.

FIG. 1 is a diagram of an input control device 10, in accordance with one embodiment of the present invention. The input control device 10 is configured to provide various inputs to a host computing device (not shown). The input control device 10 includes a touch sensing input device 12 having a touch sensitive surface 14, and a removable mechanical overlay 16 that is disposed over at least a portion of the touch sensitive surface 14 of the touch sensing input device 12.

The touch sensing input device 12 is configured to detect touches on the touch sensitive surface 14. The touch sensing device 12 reports the touches to the host computing device and the host computing device interprets the touches in accordance with its programming. For example, the host computing device may initiate a task in accordance with a particular touch. Alternatively, the touches may be processed locally at the touch input device 12 so as to reduce demand on the host computing device. The touch sensing input device 12 may for example correspond to touch pads, touch screens, or touch sensitive housings.

The mechanical overlay 16 is configured to interface with the touch input device 12 so as to produce an input mechanism with particular set of fixed mechanical inputs. The touch sensing input device 12 is capable of sensing the mechanical inputs provided by the mechanical overlay 16 and causing the host computing device to respond to those inputs. The inputs of the mechanical overlay 16 may be assignable or they may be configured for a particular application of the host computing device. For example, the mechanical overlay 16 may transform the touch sensing input device 12 into a control console or panel with particular set of fixed mechanical inputs associated with a particular application of the host computing device.

A user can have several different mechanical overlays 16, each one with controls for a specific application. For example, the user may have one mechanical overlay for video editing, another one for sound editing, another one for gaming, another one for data entry, another one for navigation, etc. The user can simply remove and insert a new mechanical overlay depending on the their needs. In essence, different overlays can be designed for different applications of the host computing system.

The input control device 10 may be a stand alone device or it may be integrated with the host computing device. In stand alone devices, the touch sensing device 12 includes its own shell and is connected to the host computing device via cables or wireless connections (e.g., touch tablet). By way of example, the touch sensing device may be a tablet sized touch pad. In integrated devices, the touch sensing device 12 is built into the shell of the host computing device. The host computing device may be a special purpose computing device or a general purpose computing device. By way of example, the host computing device may be a computer such as a PC, laptop, or tablet PC, or a handheld electronic device such as a PDA, cell phone, media player, remote control, or GPS receiver. Alternatively, the touch sensing device 12 may be built into other input devices such as keyboards or output devices such as printers.

In one embodiment, the touch sensing device 12 is a touch pad that is built into a computing device such as a laptop computer. In another embodiment, the touch sensing device 12 is a touch pad or touchscreen built into a handheld computing device such as a PDA or media player. In another embodiment, the touch sensing device 12 is a touchscreen built into a tablet PC. In another embodiment, the touch sensing device 12 is a stand alone input device that includes a tablet sized touch pad. In another embodiment, the touch sensing device 12 is a touch pad built into a peripheral input device such as keyboard. In yet another embodiment, the touch sensing device 10 is a touch sensitive palm rest on a laptop computer or a touch sensitive casing on a handheld computing device.

In order to generate the various mechanical control inputs, the mechanical overlay 16 includes one or more mechanical actuators 18 that move relative to a base 20. The base 20 is configured for removable placement over the touch sensitive surface 14 of the touch sensing input device 12 and the motion of the mechanical actuators 18 are configured to cause activation of the touch sensitive surface 14. That is, when the base 20 is placed over the touch sensitive surface 14 and when the mechanical actuators 18 are moved, the touch sensitive surface 14 senses the motion of the mechanical actuators 18 and produces signals indicative thereof (the mechanical actuators provide the touch inputs rather than a finger or stylus). As should be appreciated, the mechanical overlay 16 does not include any electronic input mechanisms, and instead relies on the input electronics of the touch sensing input device 12 to sense the mechanical action of the mechanical actuators 18.

The mechanical actuators 18 may be any mechanism that produce a physical mechanical action. By way of example, the mechanical actuators 18 may correspond to mechanical sliders 18A that slide relative to the base 20, dials 18B that rotate relative to the base 20, buttons 18C that translate up and down relative to the base 20 or switches pivot or toggle relative to the base 20. The mechanical actuators may even be more complex such as navigation pads or joysticks. In all of these cases, the mechanical actuator 18 typically includes a feature or element that can be easily sensed by the touch sensing input device 12. The feature either contacts or comes in close proximity to the touch sensitive surface 14. The contact or near contact may be continuous as for example with the slider 18A or dial 18B (e.g., moving across the touch sensitive surface) or intermittent as for example with the button 18C or switch 18D (e.g., tapping on the touch sensitive surface).

In some cases, the mechanical actuators 18 are configured to provide tactile feedback and audio feedback similarly to conventional actuators (e.g., clicks). In the case of sliders or dials, mechanical detents may be used. In the case of mechanical buttons and switches click force curves may be used. In other cases, the tactile and audio feedback may be supplied by a haptics system (e.g., speakers, solenoids, motors, piezo actuators, vibrators, etc.) located within the housing that surrounds the touch sensing input device.

The base 20 of the mechanical overlay 16 can be attached or held against the touch sensing input device 12 in a variety of different ways. By way of example, the base 20 can be attached or held against the touch sensing input device 12 by clips, pins, tabs, snaps, latches, screws, adhesive, Velcro, magnets, static attraction, vacuum (e.g., suction cups). Other examples include grooves or slots located on the touch sensing input device 12 or around the touch sensing input device 12 for receiving the base 20 and holding the mechanical overlay 16 in position. For example, the base 20 may be slid underneath a bezel or snapped into a lip at the edge of the touch sensing input device 12. In another example, the base 20 can be permanently affixed to the touch sensing input device 12.

The base 20 of the mechanical overlay 16 may be formed from a variety of materials including for example flexible and rigid materials. By way of example, the base 20 may be formed from plastics, metals and rubber like materials. The material is typically selected so as to provide tight control over the placement of the mechanical actuators 18 relative to the touch sensitive surface 14. Similarly, the mechanical actuators 18 may be formed from these materials or a combination of these materials. In order to prevent scratches on the touch sensitive surface 14, the contact surface of the mechanical actuators 18 may include highly polished metal surfaces, or scratch resistant plastic surfaces such as Teflon.

The size of the mechanical overlay 16 is typically dependent on the size of the touch sensitive surface 14 and the size and number of mechanical actuators 18 needed. In cases where it is desired to have an exposed portion of the touch sensitive surface 14 either for display or traditional touch sensing, the mechanical overlay 16 may only be configured to cover a portion of the touch sensitive surface 14. Alternatively or additionally, the mechanical overlay 16 may include a window or opening. This particular application may be beneficial in a host computing device that includes a touchscreen display.

The number of mechanical actuators 18 may be widely varied. The number of mechanical actuators 18 may be limited by the size of touch sensing device 12. In some cases, the mechanical overlay 16 only includes one mechanical actuator 18. In other cases, the mechanical overlay 16 includes enough mechanical actuators 18 so that the input control device 10 operates like a keypad or keyboard.

The touch sensing input device 12 may be based on sensing technologies including but not limited to capacitive sensing, resistive sensing, surface acoustic wave sensing, pressure sensing, optical sensing, and/or the like. Furthermore, the touch sensing device 12 may be based on single point sensing or multipoint sensing. Single point sensing is capable of only distinguishing a single touch, while multipoint sensing is capable of distinguishing multiple touches that occur at the same time.

In accordance with one embodiment, the touch sensing input device 12 is a multi-touch sensing device that has the ability to sense multiple points of contact (or near contact) and report the multiple touches to the host computing device. That is, the touch sensing input device 12 is capable of simultaneously sensing multiple touch inputs. Since the input means is capable of multi touch sensing, a user can simultaneously operate more than one of the mechanical actuators 18 at any given point in time. For example, the user may concurrently manipulate one or more sliders, dials, buttons, or any combination thereof.

The sensing technology behind the multipoint sensing device may be capacitive. In this embodiment, the mechanical actuators 18 include a grounded conductive element that can be sensed by the underlying capacitive touch surface. By way of example, the conductive portion may be a metal slug that is disposed in a plastic mechanical actuator, a metal electrode disposed or printed on the bottom surface of the plastic mechanical actuator or a metal nub that extends from a metal mechanical actuator.

The grounding of the conductive element can be accomplished by providing a ground loop between the conductive portions and the touch sensing input device 12. For example, the mechanical overlay 16 may include conductive paths that directly couple or indirectly couple (e.g., capacitively coupling, inductively coupling) the conductive portions of the mechanical actuators 18 back to the touch sensing input device 12.

In one embodiment, each of the conductive portions is electrically coupled to a conductive zone 22 on the base 20 such that when the base 20 is snapped into place, the conductive zone 22 interacts with a corresponding conductive zone 24 of the touch sensing input device 12 thereby grounding all the mechanical actuators 18 to the touch sensing input device 12. This can also be accomplished with connectors. Alternatively, the mechanical actuators 18 may include a conductive path that allows a user to be part of the grounding circuit, i.e., the ground loop is provided when the user touches the mechanical actuator.

In accordance with one embodiment, the touch sensing device 12 working solely or in combination with the host computing device coupled thereto is designed to recognize gestures applied to the touch sensitive surface 14 via the mechanical actuators 18 and to control aspects of the host computing device based on the gestures. That is, the users interaction with the mechanical actuators 18 of the mechanical overlay 16 can be such that the mechanical actuator 18 performs a gesture. A gesture may be defined as a stylized interaction with touch sensitive surface 14 that is mapped to one or more specific computing operations. The gestures may be made through various motions of the mechanical actuators 18. For example, the rotating dial 18B may perform a rotate gesture, the sliding slider 18A may perform a sliding gesture, the translating button 18C may perform a tapping gesture at a single location, and the toggling switch 18D may perform a tapping gesture at multiple locations. Depending on the application, the various gestures may be translated into various control functions.

Generally speaking, the touch sensing input device 12 receives the gestures from the mechanical actuators 18 and the host computing device executes instructions to carry out operations associated with the gestures. In some cases, the host computing device may include a gesture operational program, which may be part of the operating system or a separate application. The gestural operation program includes a set of instructions that recognizes the occurrence of gestures and informs one or more software agents of the gestures and/or what action(s) to take in response to the gestures. Examples of gestures that may be performed by the mechanical actuators can be found in U.S. patent application Ser. Nos. 10/903,964 and 11/038,590, which are herein incorporated by reference.

In accordance with one embodiment, the input control device 10 includes an ID mechanism for identifying the mechanical overlay 16 when it is positioned over the touch sensing device 12. By identifying the mechanical overlay 16, the system can automatically configure itself for specific applications. For example, placing the mechanical overlay 16 on the touch sensing device 12 may immediately launch a particular application associated with the mechanical overlay 16.

In capacitive sensing devices, the overlay 16 may consist of conductive and non conductive patches 26 that are located on the bottom of the base 20 and that form a signature for the particular overlay 16. Each overlay 16 has a different signature (different arrangement of patches) that is sensed by the capacitive touch sensing input device 12. In most cases, the signature pattern is acquired by the touch sensing input device 12 when the mechanical overlay 16 is placed over the touch sensing input device 12. In operation, the touch sensing input device 12 generates ID data associated with the signature pattern and forwards the data to a controller. When the controller recognizes the ID data, the controller configures the input panel accordingly. It should be noted, however, that this implementation is not a limitation and that other ID features may be used. For example, RF ID features or connector ID features may be used.

In accordance with one embodiment, once the overlay 16 is identified, the system can configured itself so that it expects a specific action to occur at a certain location on the touch sensitive surface 14. That is, the system can be configured to look for touch events associated with particular mechanical actuators 18 in particular zones or regions of the touch sensitive surface 14. This helps with processing the touch events, i.e., the system does not have to figure out the meaning of the touch event on the fly. The system knows that a sliding action should occur at a particular location and therefore the sliding action can be easily monitored. As shown in FIG. 2, the touch sensing input device 12 is broken up into different sensing zones 28 associated with particular mechanical actuators 18. By way of example, a slider 18A can be implemented by configuring the driver software to sense movement of a contact point along an axis. A button 18C can be implemented by configuring the driver software to sense contact at a particular point. A dial 18B can be implemented by configuring the driver software to sense movement of a contact point about an axis. The system is typically designed to configure the zones 28 according to the particular mechanical overlay 16.

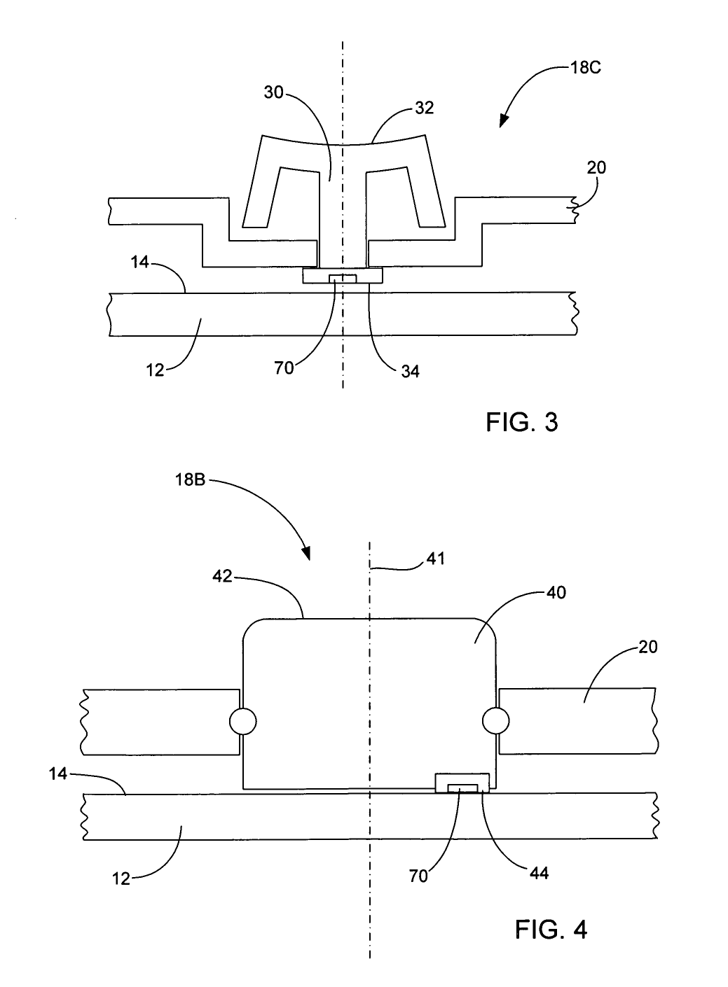

FIG. 3 is a side elevation view in cross section of a button or key 18C, which can be used on the mechanical overlay 16. As shown, the button 18C includes a plug 30 that translates up and down relative to the base 20. In some cases, the plug 30 may be spring biased to enhance the tactile feel of the button 18C and to bias the button 18C in the upward position. The spring bias may for example be provided by a coil spring, leaf spring, rubber dome, etc. The plug 30 includes a cap 32 at one end and a contact pad 34 at the other end. The cap 32 is configured to receive a finger for actuation of the button 18C, and the contact pad is configured to engage the touch surface 14 of the touch sensing input device 12 when the plug 30 is moved from the upright to depressed position. When the contact pad 34 touches the touch sensing surface 14, signals are generated by the touch sensing input device 12 in the region of the touch than can be interpreted as a button down event.

FIG. 4 is a side elevation view in cross section of a dial 18B, which can be used on the mechanical overlay 16. As shown, the dial 18B includes a wheel 40 that rotates relative to the base 20 about an axis 41. The dial 18B may include mechanical detents that provide a clicking noise as well as tactile feedback when the dial 18B is rotated. The wheel 40 includes a horizontally positioned planar disk 42 at one end and one or more contact pads 44 at the other end. The planar disc 42 is configured to receive a finger for actuation of the dial 18B, and the contact pads 44 are configured to continuously engage the touch surface 14 when the dial 18B is rotated. The contact pads 44 are placed away from the center of the wheel 40 so that the angular position of the wheel 40 can be detected by the touch sensitive surface 14. By way of example, a single contact pad may be placed at the same positioned as a locator reference arrow on the top surface of the disc 42. When the contact pad 44 is rotated about the touch sensing surface 14, signals are generated by the touch sensing input means 12 in the region of the touch than can be interpreted as a variable rotation event.

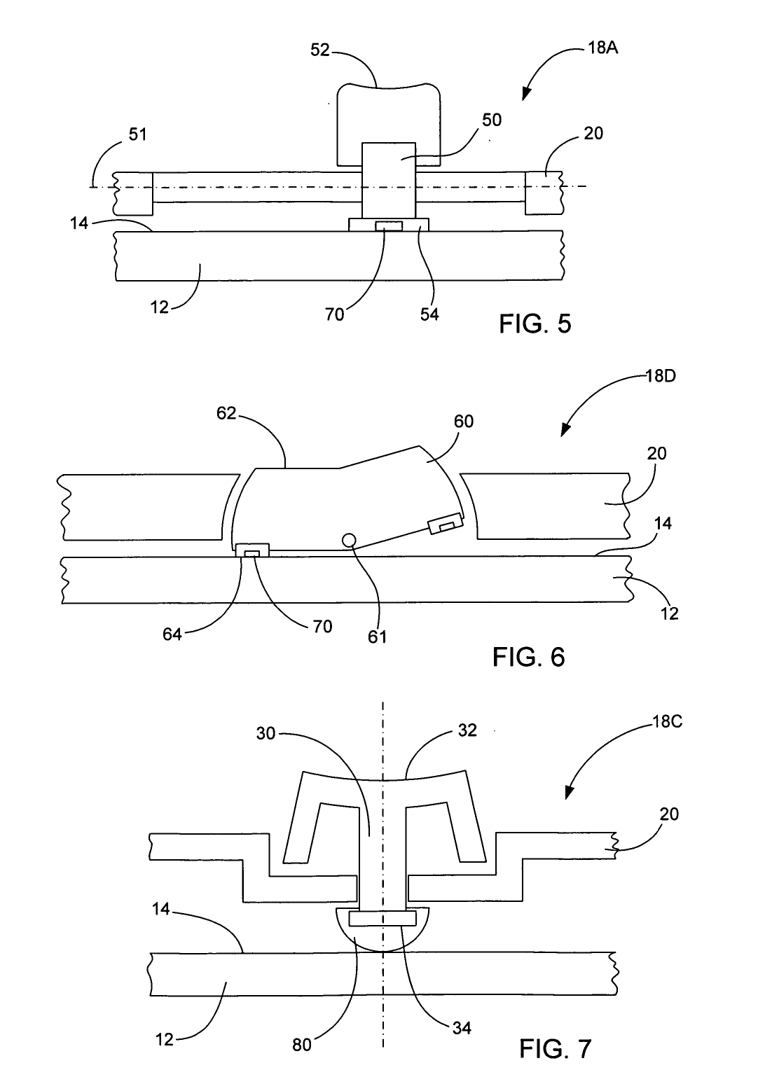

FIG. 5 is a side elevation view in cross section of a mechanical slider 18A, which can be used on the mechanical overlay 16. As shown, the slider 18A includes a plug 50 that slides relative to the base 20 along an axis 51. The slider 18A may for example be slidably coupled to the base via a flange/groove interface. The slider may include mechanical detents that provide a clicking noise as well as tactile feedback when the plug 50 is slid. The plug 50 includes a cap 52 at one end and a contact pad 54 at the other end. The cap 52 is configured to receive a finger for actuation of the slider 18A, and the contact pad 54 is configured to continuously engage the touch surface 14 of the touch sensing input means 12 when the plug 50 is moved along the axis 51. When the contact pad 54 is slid about the touch sensing surface 14, signals are generated by the touch sensing input means 12 in the region of the touch than can be interpreted as a variable sliding event.

FIG. 6 is a side elevation view in cross section of a mechanical switch 18D, which can be used on the mechanical overlay 16. As shown, the switch 18D includes a plug 60 that toggles or tilts side to side relative to the base 20. The plug 60 may for example be pivotally coupled to the base 20 via a pivot joint 61. The plug 60 may include mechanical detents that provide a clicking noise as well as tactile feedback when the plug 60 is pivoted. The plug 60 includes a cap 62 at one end and a pair of contact pads 64 at the other end. The cap 62 is configured to receive a finger for actuation of the switch 18D, and the contact pads 64 are configured to engage the touch surface 14 of the touch sensing input device 12 when the plug 60 is tilted to the left or right respectively. When the contact pads 64 touch the touch sensing surface 14, signals are generated by the touch sensing input device 12 in the region of the touch than can be interpreted as a button down event. A navigation pad or joystick operates similarly to the switch but typically with multiple pivot points so that the plug is capable of tilting to more than two positions as for example 4, 8 or 16 positions. For example a ball and socket joint may be used.

Referring to FIGS. 3-6, in cases where the touch input device 12 is a capacitive sensing device, the contact pads 34, 44, 54 and 64 may be embodied as a conductive element or include either within or on a surface of the contact pad a grounded conductive element 70 such as a metal slug or electrode. The conductive element 70 may be grounded back to the touch sensing device 12 via a ground circuit that closes when the mechanical overlay 16 is placed over the touch sensing device 12. For example, ground lines from the conductive elements may be connected to a conductive zone that couples with a corresponding conductive zone of the touch sensing device. Alternatively, the conductive element 70 may be grounded through the user when the user touches the mechanical actuator.

In some cases, the bottom surface of the contact pads 34, 44, 54 and 64 may be configured with a pliable or wear resistant material and/or have shapes that reduce wear on the touch sensitive surface 14 when the contact pad engages the surface. Alternatively, the contact pads 34, 44, 54 and 64 may not contact the touch sensing surface at all, but rather be placed just above the surface. In cases such as these, the conductive element 70 still can be sensed by the capacitive touch sensing device.

FIG. 7 is a side elevation view in cross section of a button or key 18C, which can be used on the mechanical overlay 16. Similar to the embodiment described above, the button 18C includes a plug 30 that translates up and down relative to the base 20. The plug 30 includes a cap 32 at one end and a contact pad 34 at the other end. Unlike the embodiment of FIG. 3, however, the contact pad 34 includes a deformable conductive member 80 on its bottom surface. The deformable conductive member 80 is configured to contact the touch surface 14 when the plug 30 is moved from the upright to depressed position. The deformable conductive member 80 is also configured to expand laterally as the button 18C is pushed with greater force against the touch surface 14. In some cases, the deformable conductive member 80 may be dome shaped to aid its lateral expansion. The deformable conductive member 80 may be formed from any deformable material with conductive properties. The deformable conductive member 80 may also be formed from a deformable material with a conductive layer applied thereto. For example, the conductive layer may be printed or painted on the outer surface of a non conducting deformable member such as an elastomer to form the deformable conductive member. Alternatively, the deformable member may include a flexible electrode plate or wire(s).

When the deformable conductive member 80 spreads out laterally a larger contact surface is created on the touch surface 14, and thus a larger conductive area is sensed by the touch sensitive surface 14. That is, the deformable conductive member 80 gets bigger with increased pressure. The area may be used to calculate the amount of force being exerted on the touch surface 14 (e.g., a greater area corresponds to a greater force). Furthermore, the rate of change of the area may be used to calculate the speed of the press. This particular implementation may be well suited for piano keys (where force and speed impact the notes being played). For example, the mechanical overlay 16 may include a plurality of keys that are laid out similar to a piano. Although this embodiment is shown relative to a button or key, it should be noted that it can be equally applicable to switches, navigation pads and joysticks, i.e., each toggle position includes a deformable conductive member.

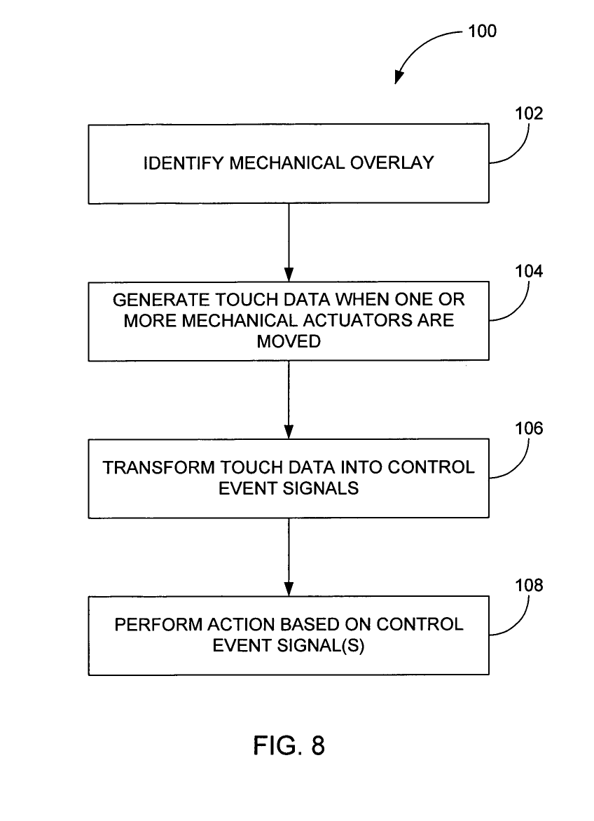

FIG. 8 is a flow diagram of an overlay method 100, in accordance with one embodiment of the present invention. The method 100 begins at block 102 where the identity of a mechanical overlay is determined. This may occur manually via a user selection or automatically via an ID mechanism. In most cases, the ID mechanism identifies the mechanical overlay when the mechanical overlay is placed over the touch sensing device.

Following block 102, the method proceeds to block 104 where touch data is generated when one or more of the mechanical actuators are moved. This block may include monitoring the movement of the mechanical actuators via the touch sensing device and recognizing actuation of specific mechanical actuators in specific zones of the touch sensing device via a software driver.

Following block 104, the method proceeds to block 106 where the touch data is transformed into control event signals. For example, the touch data may be transformed into slider event signals, dial event signals, button event signals, switch event signals, etc. This also may be accomplished with software drivers.

Following block 106, the method proceeds to block 108 where one or more actions are performed in a host computing device based on the control event signals. For example, the host computing device may use the control event signals to perform actions in an application and more particularly an application associated with the identified mechanical overlay.

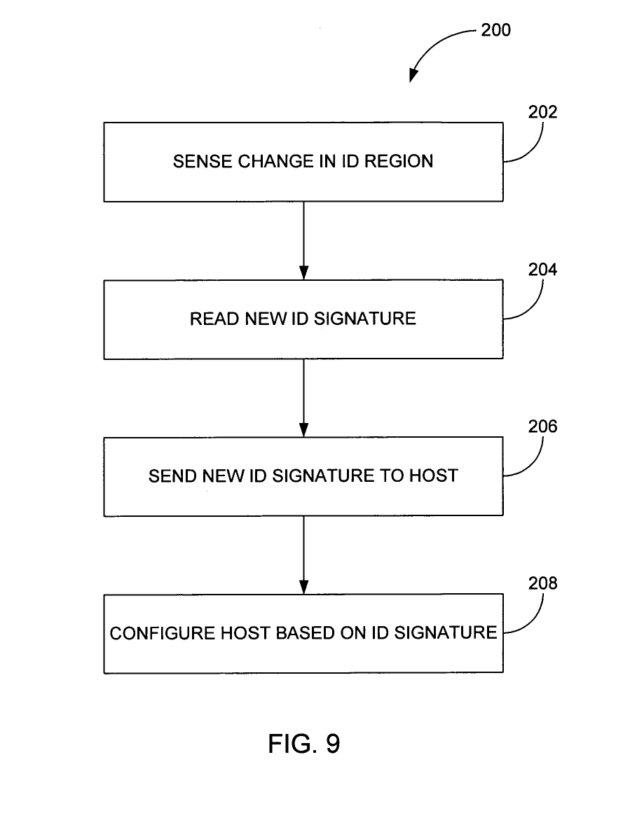

FIG. 9 is a flow diagram of an ID method 200, in accordance with one embodiment of the present invention. The method 200 generally begins at block 202 where the touch sensing means senses a change in an ID region. For example, when an overlay is first inserted or replaced. Following block 202, the method proceeds to block 204 where the touch sensing means scans or reads the new ID signature. For example, when using capacitance sensing, the contact patches can be sensed. Following block 204, the method proceeds to block 206 where the new overlay ID is sent to the host system. Thereafter, in block 208, the host system can be configured based on the ID signature. For example, an application associated with the overlay signature may be launched.

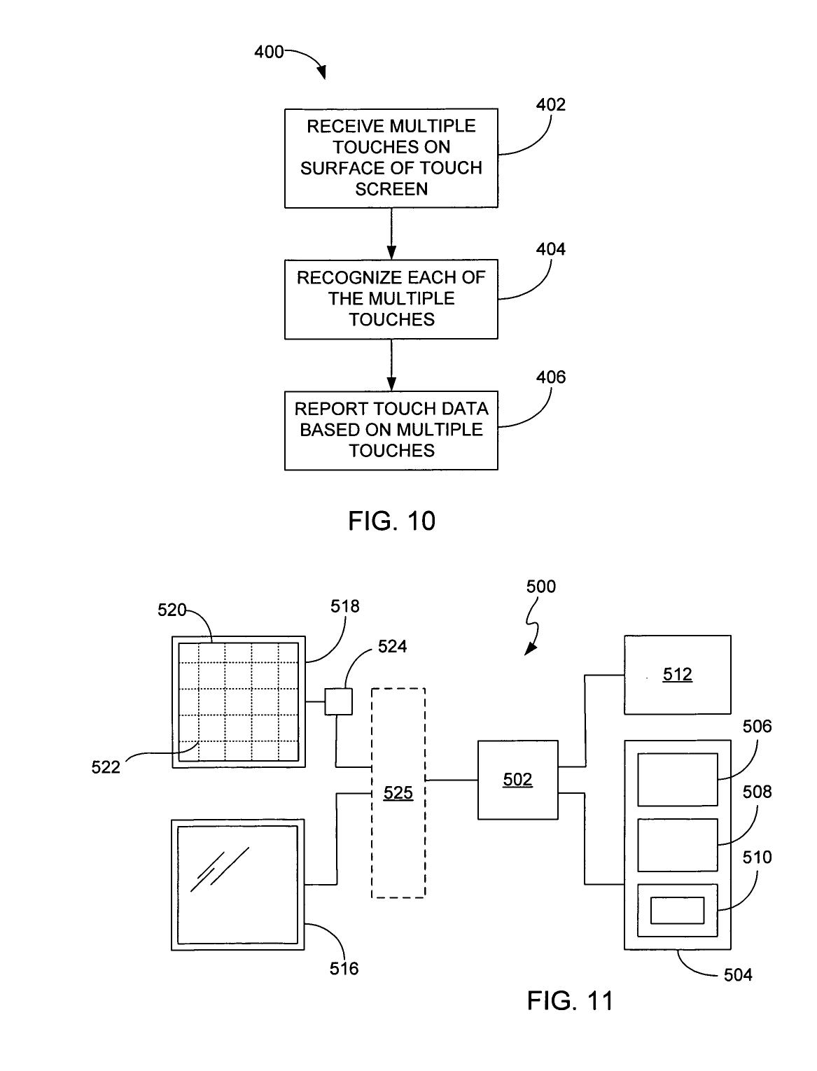

FIG. 10 is a multipoint touch method 400, in accordance with one embodiment of the present invention. The method 400 generally begins at block 402 where multiple touches are received on the surface of the touch sensing input device at the same time. This may, for example, be accomplished by multiple mechanical actuators. Following block 402, the process flow proceeds to block 404 where each of the multiple touches is separately recognized by the touch sensing input device. This may, for example, be accomplished by multipoint capacitance sensors located within the touch sensing device. Following block 404, the process flow proceeds to block 406 where the touch data based on multiple touches is reported. The touch data may, for example, be reported to a host computing device.

FIG. 11 is a block diagram of a computer system 500 in accordance with one embodiment of the invention. The computer system 500 may correspond to personal computer systems such as desktops, laptops, tablets or handhelds. By way of example, the computer system 500 may correspond to any Apple or PC based computer system. The computer system may also correspond to public computer systems such as information kiosks, automated teller machines (ATM), point of sale machines (POS), industrial machines, gaming machines, arcade machines, vending machines, airline e-ticket terminals, restaurant reservation terminals, customer service stations, library terminals, learning devices, and the like.

As shown, the computer system 500 includes a processor 502 configured to execute instructions and to carry out operations associated with the computer system 500. For example, using instructions retrieved from memory, the processor 502 may control the reception and manipulation of input and output data between components of the computing system 500. The processor 502 can be a single-chip processor or can be implemented with multiple components.

In most cases, the processor 502 together with an operating system operates to execute computer code and produce and use data. The computer code and data may reside within a program storage block 504 that is operatively coupled to the processor 502. Program storage block 504 generally provides a place to hold data that is being used by the computer system 500. By way of example, the program storage block may include Read-Only Memory (ROM) 506, Random-Access Memory (RAM) 508, hard disk drive 510 and/or the like. The computer code and data could also reside on a removable storage medium and be loaded or installed onto the computer system when needed. Removable storage mediums include, for example, CD-ROM, PC-CARD, floppy disk, magnetic tape, and a network component.

The computer system 500 also includes an input/output (I/O) controller 512 that is operatively coupled to the processor 502. The (I/O) controller 512 may be integrated with the processor 502 or it may be a separate component as shown. The I/O controller 512 is generally configured to control interactions with one or more I/O devices. The I/O controller 512 generally operates by exchanging data between the processor and the I/O devices that desire to communicate with the processor 502. The I/O devices and the I/O controller 512 typically communicate through a data link 514. The data link 514 may be a one way link or two way link. In some cases, the I/O devices may be connected to the I/O controller 512 through wired connections. In other cases, the I/O devices may be connected to the I/O controller 512 through wireless connections. By way of example, the data link 514 may correspond to PS/2, USB, FIREWIRE, IR, RF, Bluetooth or the like.

The computer system 500 also includes a display device 516 that is operatively coupled to the processor 502. The processor 502 can drive the display device 516 or a separate display driver 525 can be used. The display device 516 may be a separate component (peripheral device) or it may be integrated with a base computer system to form a desktop computer (all in one machine), a laptop, handheld or tablet or the like. The display device 516 is configured to display a graphical user interface (GUI) including perhaps a pointer or cursor as well as other information to the user. By way of example, the display device 516 may be a monochrome display, color graphics adapter (CGA) display, enhanced graphics adapter (EGA) display, variable-graphics-array (VGA) display, super VGA display, liquid crystal display (e.g., active matrix, passive matrix and the like), cathode ray tube (CRT), plasma displays and the like.

The computer system 500 also includes a touch sensing device 518 that is operatively coupled to the processor 502. The touch sensing device may for example correspond to a touch pad, touch screen or touch sensitive housing. The touch sensing device 518 is configured to receive input from a user's touch and/or the touch of a mechanical actuator and to send this information to the processor 502. In most cases, the touch sensing device 518 recognizes touches and the position and magnitude of touches on its surface. The touch screen 518 reports the touches to the processor 502 and the processor 502 interprets the touches in accordance with its programming. For example, the processor 502 may initiate a task in accordance with a particular touch.

In accordance with one embodiment, the touch sensing device 518 is capable of tracking multiple objects, which rest on, tap on, or move across the touch sensitive surface of the touch sensing device at the same time. The multiple objects may for example correspond to various mechanical actuators and/or any number of fingers. Because the touch sensing device is capable of tracking multiple objects, a user may perform several touch-initiated tasks at the same time. For example, the user may select a mechanical button with one finger, while moving a mechanical slider with another finger. In addition, a user may move a mechanical dial with one finger while touching the touch sensitive surface with another finger.

To elaborate, the touch sensing device 518 generally includes a sensing device 520 configured to detect an object in close proximity thereto and/or the pressure exerted thereon. The sensing device 520 may be widely varied. In one particular embodiment, the sensing device 520 is divided into several independent and spatially distinct sensing points, nodes or regions 522 that are positioned throughout the touch sensing device. The sensing points 522, which are typically hidden from view, are dispersed about the touch sensing device with each sensing point 520 representing a different position on the surface of the touch sensing device. The sensing points 522 may be positioned in a grid or a pixel array where each pixilated sensing point 522 is capable of generating a signal at the same time. In the simplest case, a signal is produced each time an object is positioned over a sensing point 522. When an object is placed over multiple sensing points 522 or when the object is moved between or over multiple sensing points 522, multiple signals are generated.

The number and configuration of the sensing points 522 may be widely varied. The number of sensing points 522 generally depends on the desired sensitivity of the touch screen 518 sensing device among other factors. With regard to configuration, the sensing points 522 generally map the touch sensitive plane into a coordinate system such as a Cartesian coordinate system, a Polar coordinate system, or some other coordinate system. When a Cartesian coordinate system is used (as shown), the sensing points 522 typically correspond to x and y coordinates. When a Polar coordinate system is used, the sensing points typically correspond to radial (r) and angular coordinates (θ).

The touch sensing device 518 may include a sensing circuit 524 that acquires the data from the sensing device 520 and that supplies the acquired data to the processor 502. Alternatively, the processor 502 or a separate touch sensing device driver/interface 525 may include this functionality. In one embodiment, the sensing circuit 524 is configured to send raw data to the processor 502 so that the processor 502 processes the raw data. For example, the processor 502 receives data from the sensing circuit 524 and then determines how the data is to be used within the computer system 500. The data may include the coordinates of each sensing point 522 as well as the pressure exerted on each sensing point 522. In another embodiment, the sensing circuit 524 is configured to process the raw data itself. That is, the sensing circuit 524 reads the pulses from the sensing points 522 and turns them into data that the processor 502 can understand. The sensing circuit 524 may perform filtering and/or conversion processes. Filtering processes are typically implemented to reduce a busy data stream so that the processor 502 is not overloaded with redundant or non-essential data. The conversion processes may be implemented to adjust the raw data before sending or reporting them to the processor 502. The conversions may include determining the center point for each touch region (e.g., centroid).

The sensing circuit 524 may include a storage element for storing a touch sensing program, which is capable of controlling different aspects of the touch sensing device 518. For example, the touch screen program may contain what value(s) to output based on the sensing points 522 selected (e.g., coordinates). In fact, the sensing circuit in conjunction with the touch sensing program may follow a predetermined communication protocol. As is generally well known, communication protocols are a set of rules and procedures for exchanging data between two devices. Communication protocols typically transmit information in data blocks or packets that contain the data to be transmitted, the data required to direct the packet to its destination, and the data that corrects errors that occur along the way. By way of example, the sensing circuit may place the data in a HID format (Human Interface Device).

The sensing circuit 524 generally includes one or more microcontrollers, each of which monitors one or more sensing points 522. The microcontrollers may, for example, correspond to an Application Specific Integrated Circuit (ASIC), which works with firmware to monitor the signals from the sensing device 520 and to process the monitored signals and to report this information to the processor 502.

In accordance with one embodiment, the sensing device 524 is based on capacitance. As should be appreciated, whenever two electrically conductive members come close to one another without actually touching, their electric fields interact to form capacitance. The first electrically conductive member is a sensing point 522 and the second electrically conductive member is an object 526 such as a finger or the mechanical actuator. As the object 526 approaches the surface of the touch sensing device 518, a tiny capacitance forms between the object 526 and the sensing points 522 in close proximity to the object 526. By detecting changes in capacitance at each of the sensing points 522 and noting the position of the sensing points, the sensing circuit can recognize multiple objects, and determine the location, pressure, direction, speed and acceleration of the objects 80 as they are moved across the touch screen 70.

The simplicity of capacitance allows for a great deal of flexibility in design and construction of the sensing device 520. By way of example, the sensing device 520 may be based on self capacitance or mutual capacitance. In self capacitance, each of the sensing points 522 is provided by an individually charged electrode. As an object approaches or is moved across the surface of the touch sensing device 518, the object capacitive couples to those electrodes in close proximity to the object thereby stealing charge away from the electrodes. The amount of charge in each of the electrodes is measured by the sensing circuit 524 to determine the positions of multiple objects when they touch the touch sensing device 518. In mutual capacitance, the sensing device 520 includes a two layer grid of spatially separated lines or wires. In the simplest case, the upper layer includes lines in rows while the lower layer includes lines in columns (e.g., orthogonal). The sensing points 522 are provided at the intersections of the rows and columns. During operation, the rows are charged and the charge capacitively couples to the columns at the intersection. As an object approaches the surface of the touch sensing device, the object capacitive couples to the rows at the intersections in close proximity to the object thereby stealing charge away from the rows and therefore the columns as well. The amount of charge in each of the columns is measured by the sensing circuit 524 to determine the positions of multiple objects when they touch the touch sensing device 518.

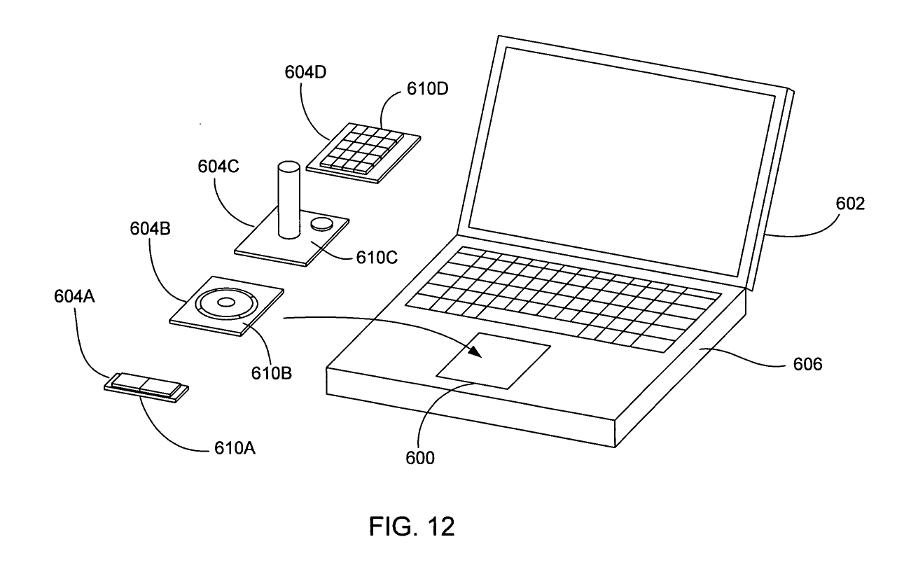

FIG. 12 illustrates an embodiment where the touch sensing input device is a touch pad 600 built into a laptop computer 602. As shown, a mechanical overlay 604 is configured for placement over the touchpad 600, which is located on the base 606 of the laptop computer 602. In some cases, the base 608 of the mechanical overlay 604 is sized to coincide with the touch pad 600 so that the mechanical overlay 604 covers the entire touch pad 600. In other cases, the mechanical overlay 604 is sized to be smaller than the size of the touch pad 600 so that a portion of the touch pad 600 can still be used conventionally. In either case, because the size of the touch pad 600 is typically small, the mechanical overlay 604 typically includes a limited number of mechanical actuators 610.

In one implementation, the mechanical overlay 604A includes one or more buttons 610A that only cover a portion of the touch pad 600. The mechanical overlay 604A can therefore eliminate the need of the conventional buttons that typically accompany the touchpad 600. This also allows the touch pad size to increase as well as gives the user the ability to select the desired button layout (one button, two buttons, etc). As should be appreciated, in conventional laptops, the buttons associated with the touch made are fixed and cannot be configured differently. In another implementation, the mechanical overlay 604B includes a horizontal scroll wheel 610B and one or more buttons 610B′. The scroll wheel 610B allows a user to easily scroll through data by a simple swirling their finger, and the buttons 610B′ allow a user to make selections and issue commands. In another implementation, the mechanical overlay 604C includes a joystick 610C and one or more buttons 610C′. This implementation may be well suited for gaming. In yet another implementation, the mechanical overlay 604D may include a numeric key pad 610D. As should be appreciated, most laptop computers do not include a numeric keypad, and thus the mechanical overlay 610D can be used to expand the functionality of the laptop computer 602.

It should be noted that the above mentioned implementations are not a limitation, but rather several embodiments of a mechanical overlay that can be used with a laptop computer. It should also be noted that these embodiments are not limited to laptop computers and can be used with other computing devices. For example, these may work well in handheld computing devices.

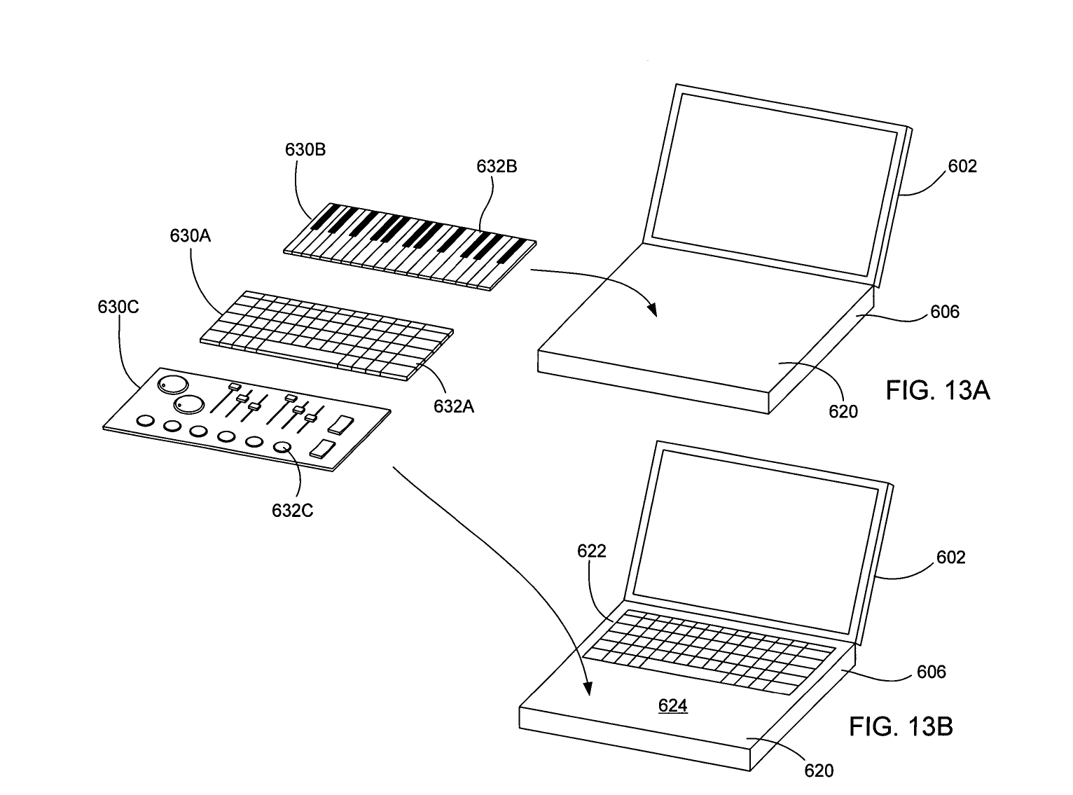

FIGS. 13A and 13B illustrate embodiments where the touch sensing input device is a touch sensitive housing member 620 located on the top surface of the base 606 of the laptop computer 602. In FIG. 13A, the laptop 602 does not include a conventional fixed keyboard, and instead a substantial portion of the top surface of the base 606 is touch sensitive. In FIG. 13B, the laptop 602 does include the fixed conventional keyboard 622 and only the palm rest portion 624 of the top surface of the base 606 is touch sensitive. In either case, because of the large size of the touch surface, the mechanical overlay 630 can include a vast number of mechanical actuators 632.

In one implementation, the mechanical overlay 630A is designed as a data entry keyboard with a plurality of keys 632A. This works well in the embodiment of FIG. 13A where the mechanical overlay 630 can be applied to the touch sensitive surface either at its conventional location at the upper portion, or somewhere else depending on the users needs. In another implementation, the mechanical overlay 630B is designed as a piano keyboard with a plurality of piano keys 632B. In yet another implementation, the mechanical overlay 630C is designed as a media mixing console having a plurality of sliders, buttons, switches and dials 632C. In some cases, the dials may be a media mixing jog shuttle that includes an outer wheel for providing coarse control and an inner wheel for providing fine control. The outer wheel may be spring biased to an initial position such that when the user stops using it, it snaps back to the initial position. As should be appreciated, both the inner and outer wheels include an element for interfacing with the touch surface, and the system is configured to recognize the motion of the elements as different touch events.

Although only large mechanical overlays are described in the embodiment of FIGS. 13A and 13B, it should be noted that this is not a limitation and that smaller mechanical overlays may be used. For example, the mechanical overlays mentioned in FIG. 12 may be used in the embodiment of FIGS. 13A and 13B. In fact, a plurality of smaller mechanical overlays can be placed on the large touch surface to produce a customized user interface for the user, i.e., the user can select the desired overlays and their arrangement on the touch surface.

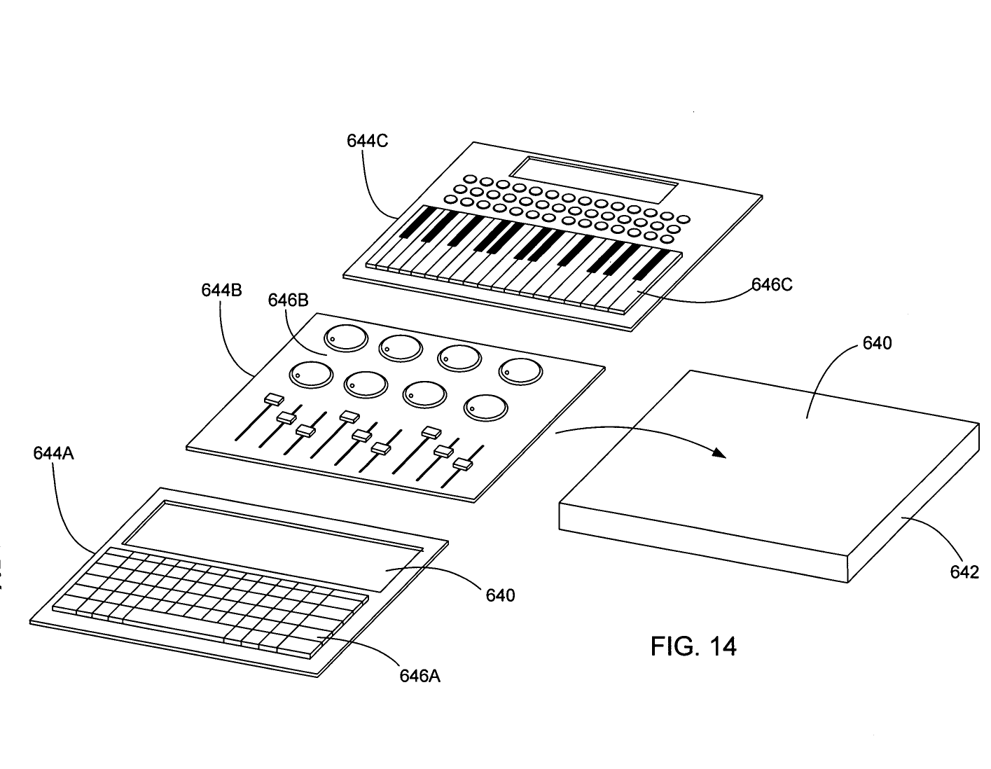

FIG. 14 illustrates an embodiment where a touch sensing input device 640 is positioned in a tablet device 642 such as a stand alone tablet touch input device with a large touch pad or a tablet PC that includes a touch screen display. In either case, a substantial portion of the top surface of the tablet device 642 is touch sensitive, and therefore the mechanical overlays 644 can include a vast number of mechanical actuators 646. Similar to the embodiments described above, the mechanical overlay 644 can be designed as a keyboard, piano or media mixing controls. It should be noted, however, that in the case of touch screen displays, the mechanical overlay 644 typically is configured to cover only a portion of the touch surface or alternatively use a cut out 648 so that a portion of the touch screen display is viewable to the user. For example, the mechanical overlay 644 may only be configured to cover the bottom half of the touch surface. This works particularly well for keyboards.

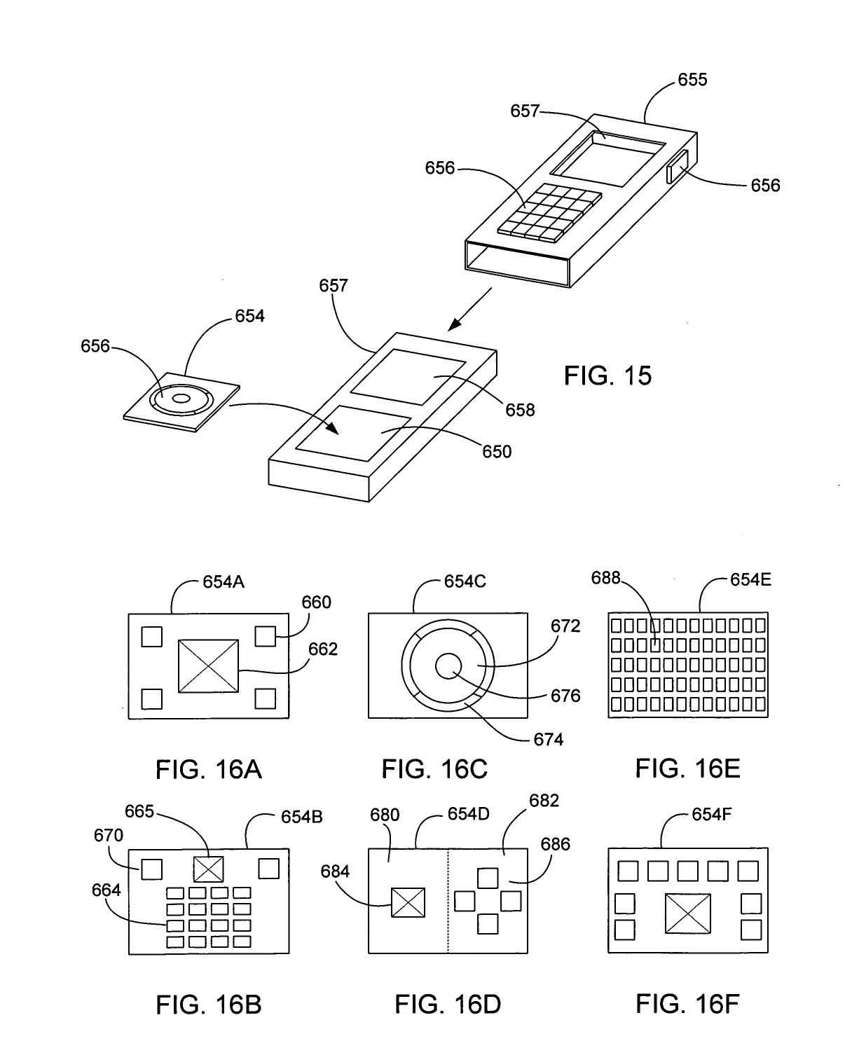

FIG. 15 illustrates an embodiment where the touch sensing input device 650 is built into a handheld electronic device 652. The touch sensing device 650 can be a touch pad, touch screen and/or touch sensitive housing. The touch sensing device 650 can be located on the on any side of the handheld electronic device 652 including for example the front, back, top, bottom, right side and/or left side. Furthermore, they can be configured to take up any amount of real estate including large (e.g., an entire side or sides) or small (e.g., a portion of a side). In one embodiment, the touch sensing device 650 is a touch pad that is positioned in the lower front of the handheld electronic device thereby leaving the upper front of the hand held electronic device for a display. In another embodiment, the touch sensing device 650 is a touch screen positioned in front of a full screen display on the front side of the hand held device. In another embodiment, the touch sensing device 650 is a touch sensitive housing of the handheld device 652.

In handheld devices, the mechanical overlay 654 may be configured as a substantially planar overlay 654 that covers the touch surface or it may be configured as a skin 655 that is slipped over a substantial portion of the handheld device 652. The skin 655 may include mechanical actuators 656 on any of its surfaces so as to interface with one or more touch sensing devices located on the many surfaces of the handheld device. For example, the mechanical actuators 656 of the skin can 655 be located on the on any side of the skin 655 including for example the front, back, top, bottom, right side and/or left side. Skins 655 with actuators 656 located on different sides works particularly well with touch sensitive housings that cover a substantial portion of the handheld device. In cases where the handheld device includes a display, the skin 655 may be formed from a transparent material and include a window portion for viewing a display 658. Alternatively, the skin 655 may be formed with an opaque material and include a transparent window or an opening 657 for viewing the display 658.

As used herein, the term “hand-held” means that the electronic device has a form factor that is small enough to be comfortably held in one hand. The hand-held electronic device may be directed at one-handed operation or two-handed operation. In one-handed operation, a single hand is used to both support the device as well as to perform operations with the user interface during use. Cellular phones, and media players are examples of hand-held devices that can be operated solely with one hand. In the case of a cell phone, for example, a user may grasp the phone in one hand between the fingers and the palm and use the thumb to make entries using keys, buttons or a joy pad. In two-handed operation, one hand is used to support the device while the other hand performs operations with a user interface during use or alternatively both hands support the device as well as perform operations during use. PDA's and game players are examples of hand-held device that are typically operated with two hands. In the case of the PDA, for example, the user may grasp the device with one hand and make entries using the other hand. In the case of the game player, the user typically grasps the device in both hands and make entries using either or both hands while holding the device.

In one embodiment, the handheld device 652 is a multifunctional hand held device, and each of the various mechanical overlays 654 or skins 655, which are configured for placement over the touch sensing device 650, corresponds to a different functionality of the multifunctional handheld device. The multi-functional hand-held device integrates the hardware and software of at least two devices into a single device. The multi-functional device may, for example, include at least two or more of the following device functionalities: PDA, Cell Phone, Music Player, Video Player, Game Player, Camera, Handtop, Internet terminal, or remote control.

In some cases, the placement of a particular overlay 654 over the touch sensing device 650 may cause the multi-functional device 652 to switch the functionality of the multi-functional device from the device functionality associated with the previous mechanical overlay to the device functionality associated with the new mechanical overlay. For example, the programming related to the current device functionality including its various layers is brought to the forefront of the multi-functional hand-held device. The programming may include reconfiguring the sensing zones of the touch sensing device so as to improve the interface between the mechanical actuators and the touch surface.

FIGS. 16A-16F show several examples of different mechanical overlays 654 that may be placed on a multi-functional device 652. The mechanical overlays 654 may be placed over a touch pad, touch screen or touch sensitive housing.

FIG. 16A is a diagram of a mechanical overlay 654A for PDA operations. As shown, the mechanical overlay 654A includes four application buttons 660 and a navigation pad 662.

FIG. 16B is a diagram of a mechanical overlay 654B for cell phone operations. As shown, the cell phone overlay 654B includes a keypad 664, a navigation pad 665 and two buttons 668 and 670.

FIG. 16C is a diagram of a mechanical overlay 654C for a Music Player operations. As shown, the mechanical overlay 654C includes a horizontal scroll wheel 672 and five buttons, four periphery buttons 674 and one center button 676. The scroll wheel 672 allows a user to scroll through song lists via rotation of the mechanical scroll wheel, the periphery buttons 674 allow user to select previous or next, play/pause or go back to the main menu, and the center button 676 allows a user to make selections.

FIG. 16D is a diagram of a mechanical overlay 654D for Game Player operations. As shown, the mechanical overlay 654D is divided into two control regions 680 and 682. In the case of a touch screen display, a window may be placed between the control regions. The left control region 680 includes a directional pad 684, and the right control region 682 includes four command buttons 686 (or vice versa).

FIG. 16E is a diagram of a mechanical overlay 654E for handtop operations. As shown, the mechanical overlay 654E includes a miniaturized keyboard 688.

FIG. 16F is a diagram of a mechanical overlay 654F for remote control operations. As shown, the mechanical overlay 654F includes various buttons 690 for controlling remote devices such as a TV, DVD player, A/V amplifier, VHS, CD player, etc.

The various aspects, embodiments, implementations or features of the invention can be used separately or in any combination.

The invention is preferably implemented by hardware, software or a combination of hardware and software. The software can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that it is flexible and provides a low cost solution for adding custom controls to a computer interface. Input devices available on the market today are often dedicated to a specific function such as video editing, sound editing, etc. The hardware is not easily reconfigured for a new task. However, the invention disclosed herein utilizes the flexibility of a touch surface allowing low cost mechanical overlays to be swapped in and out according to the task at hand. These overlays can be lower cost than a dedicated controller because they do not require electrical hardware such as switches, buttons, encoders, and associated interface electronics. By simply snapping on a new overlay and reconfiguring the host software an entirely new input experience is possible. Another advantage of the invention is that it serves to add tactile feeling controls to a touch input surface. Inherently, a touch surface offers very few tactile cues to the user. It would be possible to add a simple decal over the surface to indicate the location of the dedicated controls. However this would require the user to look carefully at the surface before touching it slowing down productivity. Furthermore, it provides no indication of whether something has been selected. This invention allows the addition of highly tactile, familiar controls to a touch surface thereby improving the experience and increasing productivity.

While this invention has been described in terms of several preferred embodiments, there are alterations, permutations, and equivalents, which fall within the scope of this invention. For example, the overlay may be configurable or customizable. That is, the base may be a component that is capable of receiving modular mechanical actuators that are snapped into the base thereby allowing a user to create a customized control panel. The host computing device can learn or be taught the placement of the mechanical actuators. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. An input control device, comprising:
a touch sensing device having a touch input area; and
a mechanical overlay provided on or over the touch input area of the touch sensing device, the mechanical overlay having one or more mechanical input mechanisms that provide the touch input to the touch input area via a mechanical action.

2. The input control device as recited in claim 1 wherein the touch sensing device is a touch pad.

3. The input control device as recited in claim 1 wherein the touch sensing device is a touch screen positioned over a display.

4. The input control device as recited in claim 1 wherein the touch sensing device is a touch sensitive housing.

5. The input control device as recited in claim 1 wherein the touch sensing device is a multi-touch sensing device capable of detecting multiple touches that occur at the same time.

6. The input control device as recited in claim 1 wherein the touch sensing device is a capacitive touch sensing device.

7. The input control device as recited in claim 1 wherein the touch sensing means is configured to recognize gestures applied to the touch sensitive surface via the mechanical input mechanisms of the mechanical overlay.

8. The input control device as recited in claim 1 further including an ID mechanism for identifying the mechanical overlay when it is positioned over the touch sensing device.

9. The input control device as recited in claim 1 wherein the touch surface is broken up into regions, the regions being located in the area of the mechanical input mechanisms.

10. A mechanical overlay for a touch sensing device, the mechanical overlay comprising:
a base configured for placement on or over a touch sensitive surface of the touch sensing device; and
one or more mechanical actuators that move relative to the base, the motion of the mechanical actuators being configured to cause activation of the touch sensitive surface of the touch sensing device.

11. The mechanical overlay as recited in claim 10 wherein the mechanical overlay does not include any electronic input mechanisms.

12. The mechanical overlay as recited in claim 10 wherein the mechanical actuator is a slider that slides relative to the base.

13. The mechanical overlay as recited in claim 10 wherein the mechanical actuator is a dial that rotates relative to the base.

14. The mechanical overlay as recited in claim 10 wherein the mechanical actuator is a button that translates relative to the base between an upright and depressed position.

15. The mechanical overlay as recited in claim 14 wherein the mechanical actuator is a switch that toggles relative to the base.

16. The mechanical overlay as recited in claim 10 wherein the mechanical actuators include a feature that is easily sensed by the touch sensing device.

17. The mechanical overlay as recited in claim 16 wherein the touch sensing device is a capacitive sensing device, and wherein the mechanical actuators include a grounded conductive element that can be sensed by the underlying capacitive touch surface.

18. The mechanical overlay as recited in claim 10 wherein the base includes an opening, which provides access to the touch sensitive surface when the mechanical overlay is positioned on or over the touch sensing device.

19. The mechanical overlay as recited in claim 10 wherein the mechanical overlay is configured as a keyboard or keypad including a plurality of mechanical actuators in the form of keys.

20. The mechanical overlay as recited in claim 10 wherein the mechanical overlay is configured as media mixing console including a plurality of mechanical actuators selected from at least sliders and dials.

21. The mechanical overlay as recited in claim 10 wherein the mechanical overlay is user interface for a handheld device.

22. The mechanical overlay as recited in claim 21 wherein the base of the mechanical overlay is configured as a skin that is slipped over a substantial portion of the handheld device.

23. The mechanical overlay as recited in claim 10 wherein the mechanical actuators are selected from buttons, sliders, switches, dials, navigation pads or joysticks.

24. A mechanical overlay for a touch sensing device, the mechanical overlay comprising:
a base configured for placement on or over a touch sensitive surface of the touch sensing device; and
one or more mechanical actuators that move relative to the base, the motion of the mechanical actuators being configured to cause activation of the touch sensitive surface of the touch sensing device, the one or more mechanical actuators including at least a button that translates relative to the base between an upright and depressed position, the button activating the touch sensitive surface when the button is moved from the upright to the depressed position.

25. The mechanical overlay as recited in claim 24 wherein the button includes a plug that translates up and down relative to the base, the plug including a contact pad at a bottom end, the contact pad engaging the touch sensitive surface of the touch sensing device when the plug is moved from an upright to depressed position.

26. The mechanical overlay as recited in claim 25 further including a deformable member at the bottom surface of the contact pad, the deformable member being configured to expand laterally as the plug is moved from the upright to depressed positions with greater force against the touch sensitive surface of the touch sensing device, the lateral expansion of the deformable member indicating the increased force that is being exerted on the plug as it is moved from the upright to the depressed position.

27. The mechanical overlay as recited in claim 25 wherein the touch sensing device is based on capacitance and wherein the deformable member includes a conductive element that interacts with the capacitive touch sensing device.

28. A computing device, comprising:
a touch surface provided by one of a touch pad, touch screen or touch sensitive housing;
a mechanical overlay including one or more mechanical actuators that interface with the touch surface in order to generate touch inputs, the touch inputs being used by the computing device to perform actions in the computing device.

29. The computing device as recited in claim 28 wherein the computing device is a personal computer, laptop computer, or tablet personal computer.

30. The computing device as recited in claim 28 wherein the computing device is a handheld computing device.

31. An overlay method, comprising:
determining the identity of a mechanical overlay;
generating touch data when one or more mechanical actuators of the mechanical overlay are moved;
transforming the touch data into control event signals; and
performing one or more actions based on the control event signals.

32. A method performed in a control input device having a touch sensing device and a mechanical overlay, the method comprising:
sensing a change in an ID region of the touch sensing device, the change occurring when a new mechanical overlay is positioned over the touch sensing device;
reading the ID signature of the new mechanical overlay when a change is sensed in the ID region; and
registering the ID signature and configuring a host system based on the ID signature.

33. A control panel, comprising:
a removable mechanical overlay including a plurality of mechanical actuators selected from at least sliders, buttons, dials or switches; and
a touch sensing device configured to recognize multiple touch event generated by the plurality of actuators at the same time, and to report the multiple touch events to a host computing device.

34. The control panel as recited in claim 33 wherein the touch sensing device includes capacitive sensors, and wherein each of the mechanical actuators includes a grounded conductive element that interacts with the capacitive sensors of the touch sensing device.

35. The control panel as recited in claim 33 wherein the touch sensing device is a touch screen that is built into a tablet computer.

36. The control panel as recited in claim 33 wherein the touch sensing device is standalone tablet sized touchpad.

37. A computing device, comprising:
a touch sensing device having a touch sensitive surface;
a removable mechanical overlay for placement over the touch sensitive surface, the removable mechanical overlaying including an identification (ID) feature and one or more mechanical actuators for interacting with the touch sensitive surface, wherein
the computing device is configured to identify the mechanical overlay via the ID feature of the mechanical overlay, and to configured itself based on the identified mechanical overlay.

38. The computing device as recited in claim 37 wherein configuring the computing device includes looking for touch events associated with a particular mechanical actuator of the mechanical overlay in a particular region of the touch sensitive surface.

39. The computing device as recited in claim 37 wherein the touch sensing device is based on capacitance, and wherein the ID feature of the mechanical overlay includes conductive and non conductive patches for placement over the touch sensitive surface of the capacitive touch sensing device, the conductive and non conductive patches forming a signature of the mechanical overlay.
